(19) United States
(12) Patent Application Publication
(10) Pub. No.: US 2026/0296325 A1
(43) Pub. Date: Oct. 1, 2026

(54) SEAT BACK POCKET FOR VEHICLES AND MANUFACTURING METHOD THEREOF

(71) Applicants: HYUNDAI MOTOR COMPANY, SEOUL (KR); KIA CORPORATION, SEOUL (KR); ADIENT KOREA, INC., ASAN-SI (KR); U.M.S. CO., LTD, HWASEONG-SI (KR)

(72) Inventors: Yeong-Hoon Seo, Hwaseong-si (KR); Hong-Sik Chang, Hwaseong-si (KR); Seung-Chan Choe, Hwaseong-si (KR); Hae-Joo Kim, Hwaseong-si (KR); Seong-Hyeon Shin, Hwaseong-si (KR); Hyo-Cheol Kang, Hwaseong-si (KR); Jung-Sang You, Hwaseong-si (KR); Chung-Heum Baek, Asan-si (KR); Dae-Sic Moon, Asan-si (KR); Hyeong-Chul Lee, Asan-si (KR); Jae-Hoon Kang, Asan-si (KR); Sung-Jun Song, Hwaseong-si (KR); Jin-Young Yoo, Hwaseong-si (KR); Dong-Bog An, Asan-si (KR)

(73) Assignees: HYUNDAI MOTOR COMPANY, SEOUL (KR); KIA CORPORATION, SEOUL (KR); ADIENT KOREA, INC., ASAN-SI (KR); U.M.S. CO., LTD, HWASEONG-SI (KR)

(21) Appl. No.: 19/555,404

(22) Filed: Mar. 3, 2026

(30) Foreign Application Priority Data
Mar. 27, 2025 (KR) 10-2025-0039416
Sep. 16, 2025 (KR) 10-2025-0132587

(51) Int. Cl. B60R 7/04; B60N 2/90

(52) U.S. Cl. CPC B60R 7/04; B60N 2/90

(57) ABSTRACT

A seat back pocket for vehicles includes a front portion including a backing cloth, an outer cloth, and a support portion between the backing cloth and the outer cloth, a retainer bracket coupled to a seatback panel of a vehicle, and a side portion disposed between the front portion and the retainer bracket to form a storage space.

### CROSS REFERENCE TO RELATED APPLICATIONS

This application claims priority to Korean Patent Application No. 10-2025-0039416, filed on Mar. 27, 2025, and Korean Patent Application No. 10-2025-0132587, filed on Sep. 27, 2025, both of which are incorporated herein by reference in their entirety.

### BACKGROUND

### Field

Embodiments disclosed in the present specification relate to a seat back pocket mounted on a seat back of a vehicle and a manufacturing method thereof.

### Description of Related Art

Plastic-structured seat back pockets have narrow inner storage space and rigid surfaces, making it difficult to store large items other than tablet PCs and often causing passenger inconvenience.

For example, the seat back panel assembly is configured to include an inner reinforcement bracket connected to a main back panel, rubber banding, and a plastic back pocket with an opening/closing mechanism that users open and close. However, the component arrangement and spatial structure make it prone to item loss when storing various user belongings (such as tablet PCs, mobile phones, cosmetics, wallets, etc.), and may cause inconvenience to users.

The information described in the Background section above is provided to facilitate understanding of the background of the present disclosure and may include information that is not the related art known to those skilled in the art to which the present disclosure pertains.

### SUMMARY

Embodiments disclosed in the present specification are designed to solve the above problems. The embodiments disclosed in the present specification aim to provide a seat back pocket and a manufacturing method thereof that may offer improved usability compared to existing designs for storing items of various sizes and materials.

A seat back pocket for vehicles according to an aspect of an embodiment disclosed in the present specification may include a front portion including a backing cloth, an outer cloth, and a support portion between the backing cloth and the outer cloth, a retainer bracket coupled to a seatback panel of a vehicle, and a side portion disposed between the front portion and the retainer bracket to form a storage space.

In addition, the retainer bracket may be made of a plastic material and be fusion-bonded to the seatback panel.

In addition, the backing cloth, the outer cloth, and the support portion may be made of a polymer material.

Furthermore, the backing cloth and the outer cloth may be stretchable polymer fabrics, and the support portion may be a polymer foam.

In addition, the backing cloth and the outer cloth may be bonded to the support portion, and the backing cloth may be hot-melt bonded to the support portion.

Furthermore, the seat back pocket may further include a rear portion configured to wrap around the front and a lateral portion of the retainer bracket.

In addition, the seat back pocket may further include an inner portion configured to cover a part of a rear surface of the retainer bracket. The inner portion, the rear portion, and the retainer bracket may be coupled.

In addition, an upper portion and a part of a lateral portion of the side portion may be provided with cutouts, and zipper rails may be formed at both ends of the cutout, facing each other. The seat back pocket may further include a zipper slider coupled to the zipper rail.

Furthermore, the front portion may be thicker than the side portion.

In addition, the front portion may include curved portions formed at both end portions, and the support portion may be formed on the curved portion.

In addition, the support portion may include a plurality of protruding portions, and the plurality of protruding portions may be spaced apart along a transverse direction and protrude in a thickness direction.

Next, a manufacturing method of a seat back pocket for vehicles according to an embodiment disclosed in the present disclosure may include bonding a backing cloth to a surface of a polymer foam by hot-melt treatment, performing primary hot forming of the polymer foam, bonding a polyurethane outer cloth to the other surface of the polymer foam and performing secondary hot forming, and performing cold forming of the polymer foam and the outer cloth.

Here, the primary hot forming may be performed at 180° C. to 190° C.

In addition, the secondary hot forming may be performed at 120° C. to 130° C.

In addition, the cold forming may be performed at room temperature (20±5° C.).

Furthermore, the manufacturing method may further include coupling a retainer bracket, coupled to a vehicle seatback panel, to a front portion of the seat back pocket in which the polymer foam and the outer cloth are thermoformed.

The embodiments disclosed in the present specification provide a pocket and zipper configuration made of a sponge material instead of plastic, which may offer improved usability compared to existing designs for storing items of various sizes and materials.

### BRIEF DESCRIPTION OF THE FIGURES

FIG. 1 is an exploded perspective view of a seat back pocket according to an embodiment disclosed in the present specification.

FIG. 2 is a front view of a seat back pocket according to an embodiment disclosed in the present specification.

FIG. 3 is a rear view of a seat back pocket according to an embodiment disclosed in the present specification.

FIG. 4 is a cross-sectional view taken along line A-A′ of FIG. 2.

FIG. 5 is a cross-sectional view taken along line B-B′ of FIG. 2.

FIG. 6 is a front view of a seat back pocket for additional description according to an embodiment disclosed in the present specification.

FIG. 7 is a cross-sectional view taken along line C-C′ of FIG. 6 according to an embodiment.

FIG. 8 is a cross-sectional view taken along line D-D′ of FIG. 6.

FIG. 9 is a schematic view of FIG. 8.

FIG. 10 is a cross-sectional view taken along line C-C′ of FIG. 6 according to another embodiment.

FIG. 11 is a cross-sectional view taken along line D-D′ of FIG. 6.

FIG. 12 is a cross-sectional view taken along line C-C′ of FIG. 6 according to still another embodiment.

FIG. 13 is a cross-sectional view taken along line D-D′ of FIG. 6.

FIG. 14 illustrates a manufacturing method of a seat back pocket according to an embodiment.

### DETAILED DESCRIPTION

To fully understand the present disclosure, operational advantages, and objectives achieved by embodiments of the present disclosure, it is necessary to refer to the attached drawings illustrating preferred embodiments of the present disclosure and the contents stated therein.

In describing preferred embodiments of the present disclosure, known techniques or repetitive descriptions that may unnecessarily obscure the gist of the present disclosure will be reduced or omitted.

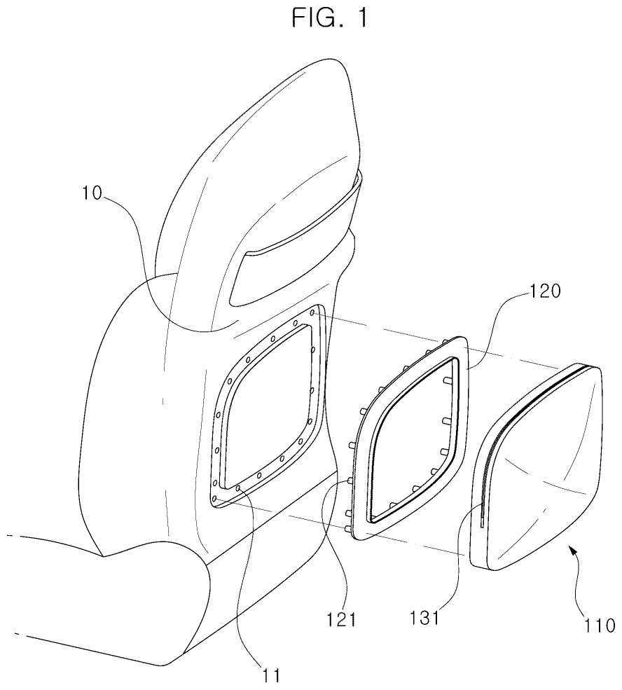

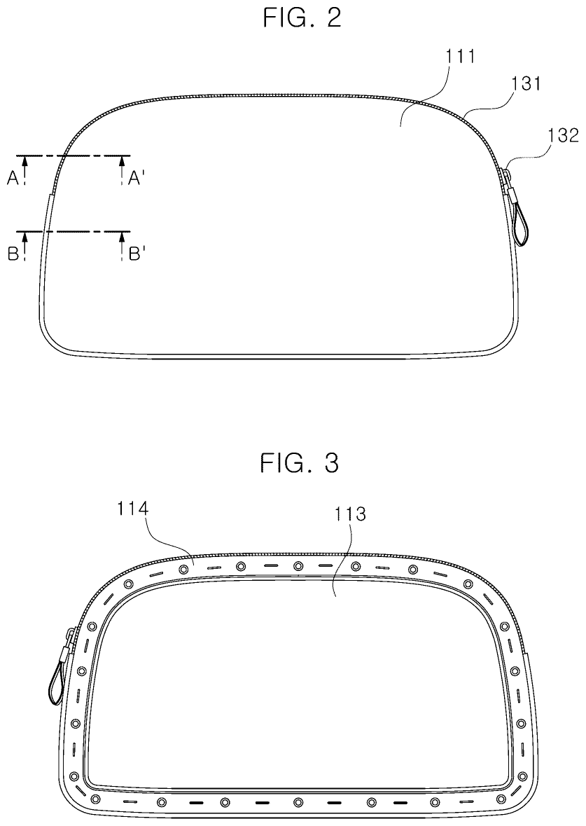

FIG. 1 is an exploded perspective view of a seat back pocket according to an embodiment disclosed in the present specification. FIG. 2 is a front shape of a seat back pocket according to an embodiment disclosed in the present specification. FIG. 3 is a rear shape of a seat back pocket according to an embodiment disclosed in the present specification.

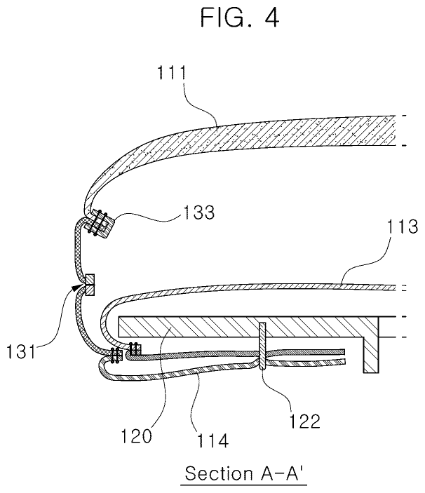

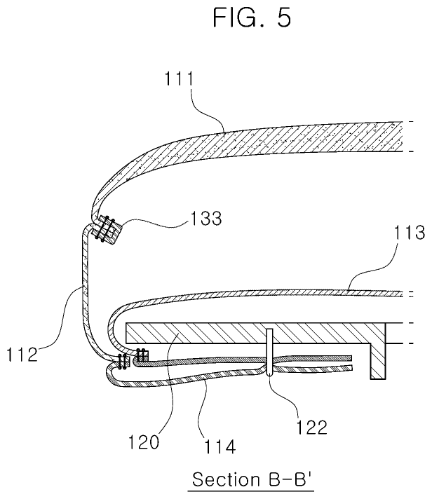

In addition, FIG. 4 is a cross-sectional view taken along line A-A′ of FIG. 2, and FIG. 5 is a cross-sectional view taken along line B-B′ of FIG. 2.

A seat back pocket according to an embodiment disclosed in the present specification and a manufacturing method thereof will be described below with reference to FIGS. 1 to 5.

The seat back pocket according to an embodiment disclosed in the present specification is configured to include an inner retainer bracket 120 formed of PP (polypropylene) plastic and connected to a seatback panel 10 of a seatback panel assembly, and a cover portion of a thermoformed sewn product configured as a zipper pocket 110 that is fusion-bonded to the seatback panel 10.

For example, to ensure a maximum storage space of 380×220×30 for convenient storage of a user's belongings, the pocket is made of soft materials, specifically SLAB FOAM (soft polyurethane foam) and PU (polyurethane) fabric, to prevent scratches and damage to stored items, thereby allowing safe storage of the user's belongings (such as tablet PCs, mobile phones, cosmetics, wallets, etc.).

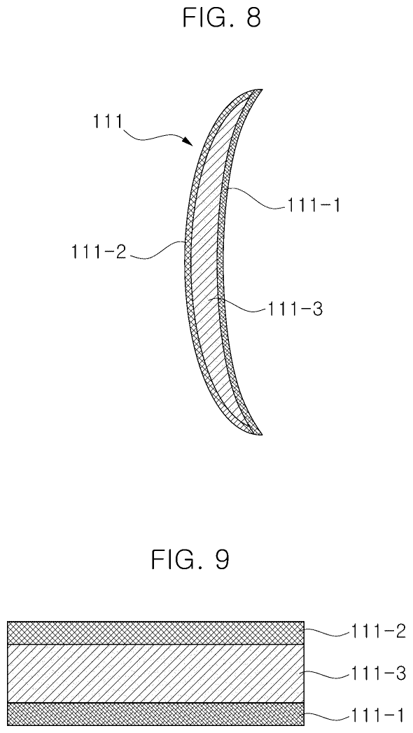

Referring to FIGS. 7-13, the pocket includes a backing cloth 111-1 and an outer cloth 111-2. The cover portion is configured to include a front portion 111 exposed toward the rear seat, a side portion 112, and a rear portion 113 of the thermoformed sewn product, such that a storage space is formed between the front portion 111 and a retainer bracket 120, which will be described later. As illustrated, the front portion 111 and the side portion 112 may be integrally formed, and an inner portion 114 to be described later may be sewn to an end portion of the side portion 112.

Here, the backing cloth 111-1 and the outer cloth 111-2 may be stretchable polymer fabrics, and the backing cloth 111-1 may be made of polyester or polyurethane.

In addition, a support portion 111-3 may be a polymer foam.

Furthermore, the rear portion 113 is separately coupled to the retainer bracket 120 together with the inner portion 114.

The side portion 112 includes an upper portion, a lower portion, and a lateral portion, wherein the upper portion and a part of the lateral portion are provided with cutouts, and zipper rails 131 are formed at both ends of the cutout, facing each other. The pocket 110 is opened and closed by a zipper slider 132 engaged with the zipper rails 131. Reference numeral 133 denotes a zipper sewn portion.

Accordingly, the zipper, which facilitates opening and closing, is sewn to the thermoformed cover, and the inner retainer bracket 120 is positioned inside the sewn product. The retainer bracket 120 is arranged on the rear surface of the rear portion 113, and, as illustrated, a lateral portion of the rear portion 113 is configured to wrap around the front and a lateral portion of the retainer bracket 120.

Furthermore, the inner portion 114 is arranged to wrap around the rear surface of the retainer bracket 120 and is coupled using a staple 122.

In addition, the seat back pocket is fixed by fusion-bonding protrusions of a main back panel and the retainer bracket 120. That is, protrusions 121 formed on the retainer bracket 120 are inserted into protrusion holes 11 formed in the seatback panel 10 and fusion-bonded.

In addition, the opening/closing mechanism for the storage space may be other than a zipper.

Furthermore, in one embodiment, to reduce the possibility that the mounted pocket 110 may not recover and may form wrinkles when pressed by an external force, the support portion 111-3, which is a thermoformed thickened portion, may be formed on the front portion 111.

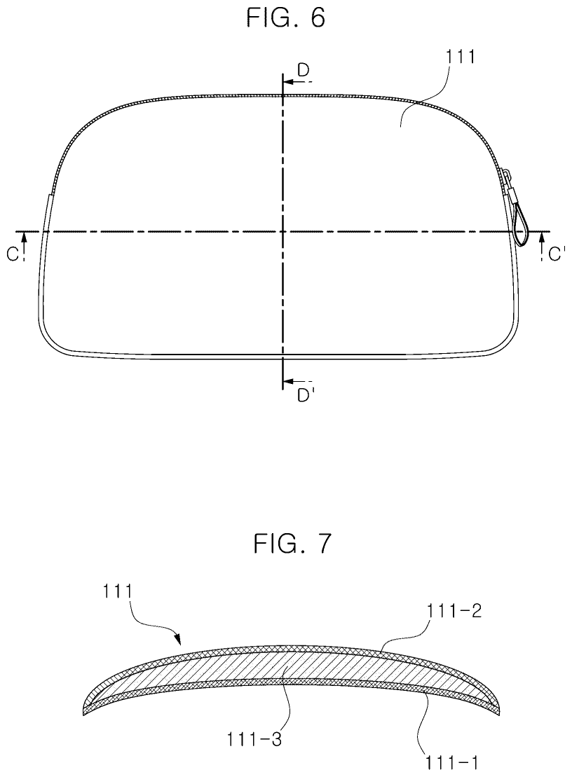

That is, as shown in FIGS. 7 to 9 based on FIG. 6, the front portion 111 may include a support portion 111-3 of sponge-type PU foam formed between the backing cloth 111-1 and the outer cloth 111-2 to increase the thickness. The manufacturing method thereof will be described later.

The backing cloth 111-1 may be a stretch fabric with elongation properties for shape retention during thermoforming, and materials such as polyester and polyurethane may be used.

The sponge slab pad may have a density of 28 kg/m³, and high-hardness foam may be used to provide enhanced thermoformability.

The backing cloth may be bonded to the sponge slab pad by hot-melt treatment.

The outer cloth 111-2 is bonded when the support portion 111-3 and the backing cloth 111-1 are in a hot-melted state, and the outer cloth may be made of polyurethane (PU).

Accordingly, the backing cloth 111-1 and the outer cloth 111-2 are bonded to the support portion 111-3, and the backing cloth 111-1 may be hot-melt bonded to the support portion 111-3.

Furthermore, the surface melting point of the PU (PVC) corresponding to the outer cloth 111-2 is 140° C., and the temperature is set to 120° C. to 130° C. to prevent changes in the design pattern and achieve a rounding effect, whereas the forming temperature of the sponge slab pad is in the 180° C. range, which is advantageous for maintaining appearance quality by preserving the appropriate thickness of the pocket.

In addition, the outer cloth 111-2 may be a PU UB type fabric having a tensile strength of 35 kgf/mm² and an elongation of 81%, exhibiting high stretchability.

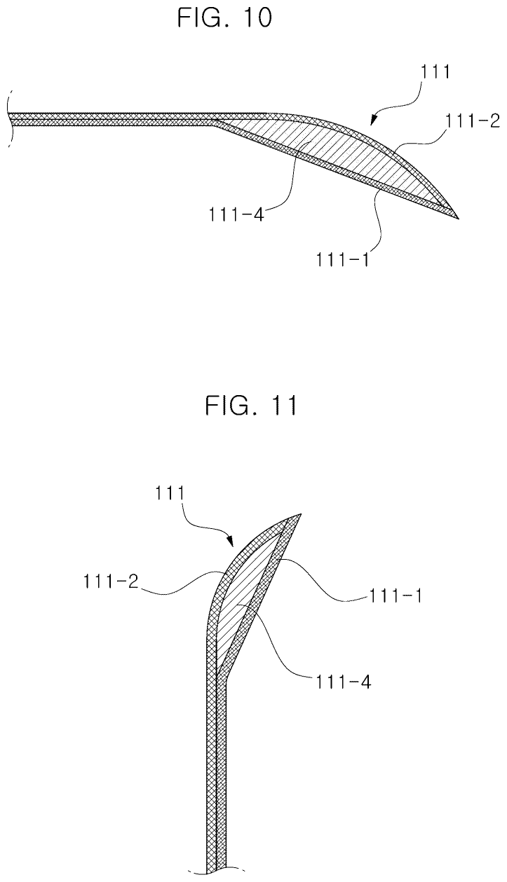

As an application example, as shown in FIGS. 10 and 11, the front portion 111 of the pocket 110 may include a curved portion formed at the end portion, and a support portion 111-4 may be formed exclusively at the curved portion.

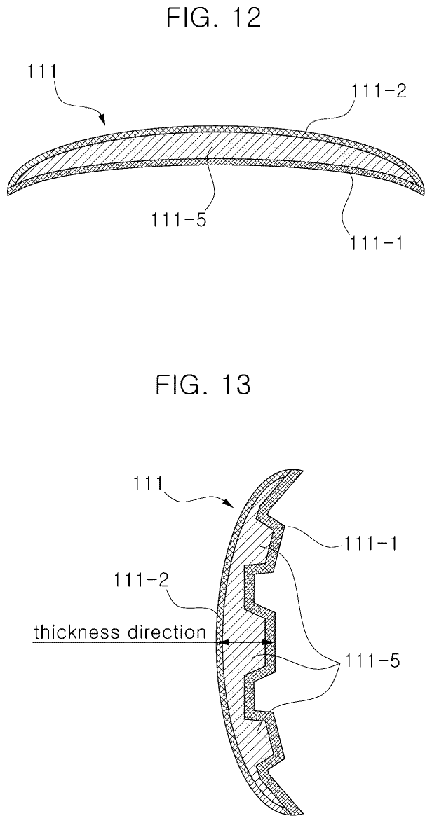

Furthermore, as shown in FIGS. 12 and 13, the support portion may include protruding portions 111-5 that are spaced apart along the transverse direction of the front portion 111 and protrude in the thickness direction.

The mold and manufacturing conditions designed for these protruding portions may prevent the possibility of non-recoverable deformation of the pocket 110.

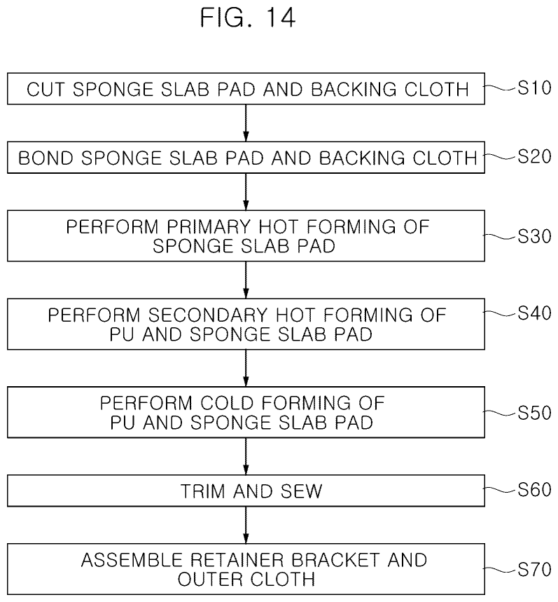

Next, with reference to FIG. 14, a manufacturing method of a seat back pocket according to an embodiment disclosed in the present specification will be described.

The front portion 111 may include the support portion 111-3 (7T) made of a sponge material, formed between the backing cloth 111-1 and the outer cloth 111-2, and a manufacturing method thereof will be described.

First, the sponge slab pad and the backing cloth are cut (S10). The backing cloth may be a polymer with elongation properties for shape retention during thermoforming, and materials such as polyester or polyurethane may be used.

The slab pad may have a density of 28 kg/m³, and high-hardness foam is used to provide enhanced thermoformability.

Next, the backing cloth is bonded to the sponge slab pad by hot-melt treatment (S20). This serves as an adhesive between the sponge slab pad and the backing cloth during thermoforming, and the hot-melt temperature may be 130° C. to 140° C.

Then, the sponge slab pad undergoes primary hot forming (S30).

The upper plate (180° C.) of the mold contacts the sponge slab pad and applies heat, and the lower plate (189° C.) contacts the backing cloth and applies heat.

The lower plate is set at a relatively higher temperature to melt the hot melt for enhanced bonding performance and to ensure that the support portion (sponge) is formed at an appropriate temperature (180° C.), taking into account the thermal energy absorbed by the backing cloth layer. This process bonds the support portion (sponge) and the backing cloth together.

Next, the PU and the sponge slab pad undergo secondary hot forming (S40).

The outer cloth 111-2 is attached (bonded) after the support portion 111-3 and the backing cloth 111-1 are hot-melted, and low-temperature (130° C.) hot forming is performed. Since the outer cloth is the externally visible portion, forming at excessive temperatures (180° C.) may cause defects in appearance quality. Therefore, this is performed as a separate process.

That is, the surface melting point of the PU (PVC) corresponding to the outer cloth is 140° C., and the temperature is set to 120° C. to 130° C. to prevent changes in the design pattern and achieve a rounding effect, whereas the forming temperature of the sponge slab pad is in the 180° C. range. This is to maintain appearance quality by preserving the appropriate thickness of the pocket 110.

In addition, the outer cloth may be a PU UB type fabric having a tensile strength of 35 kgf/mm² and an elongation of 81%, exhibiting high stretchability.

Next, the PU and the sponge slab pad undergo tertiary cold forming (S50).

Cold forming is performed with the support portion 111-3, the backing cloth 111-1, and the outer cloth 111-2 in a bonded state to retain the shape of the outer cloth and improve adhesive strength.

The upper plate (PU bonding portion) and the lower plate (cloth bonding portion) may be set at room temperature (20±5° C.), and pressure may be applied to form the shape.

This is to ensure that the bonding liquid, melted during hot melting at 120° C. to 130° C., retains the shape and improves adhesive strength at room temperature.

Subsequently, the integrated backing cloth, slab pad, and outer cloth are trimmed using a metal mold, and the backing cloth and the outer cloth are sewn together with the zipper (S60).

Then, the retainer bracket 120 is assembled with the outer cloth (S70), and finishing work is performed on the zipper and the tacker (staple tacker) 122 to complete manufacturing. The primary purpose of the tacker 122 is to bond the outer cloth and the retainer, and the tacker also serves to secure the pocket module to the seat back.

While the present disclosure has been described with reference to the embodiments illustrated in the drawings, it will be obvious to those skilled in the art that the present disclosure is not limited to the disclosed embodiments, but may be variously modified and arranged without departing from the technical spirit and scope of the present disclosure. Thus, it is to be understood that the present disclosure is intended to cover various modifications and arrangements within the scope of the appended claims. Accordingly, the scope of the present disclosure should be defined by following claims.

1. A seat back pocket for vehicles, the seat back pocket comprising:
a front portion including a backing cloth, an outer cloth, and a support portion positioned between the backing cloth and the outer cloth;
a retainer bracket coupled to a seatback panel of a vehicle; and
a side portion positioned between the front portion and the retainer bracket to form a storage space.

2. The seat back pocket of claim 1, wherein the retainer bracket comprises a plastic material and is fusion-bonded to the seatback panel.

3. The seat back pocket of claim 1, wherein the backing cloth, the outer cloth, and the support portion comprise a polymer material.

4. The seat back pocket of claim 3, wherein the backing cloth and the outer cloth comprise stretchable polymer fabrics, and the support portion comprises a polymer foam.

5. The seat back pocket of claim 3, wherein the backing cloth and the outer cloth are bonded to the support portion, and the backing cloth is hot-melt bonded to the support portion.

6. The seat back pocket of claim 1, further comprising:
a rear portion configured to wrap around a front and a lateral portion of the retainer bracket.

7. The seat back pocket of claim 6, further comprising:
an inner portion configured to cover a part of a rear surface of the retainer bracket, wherein the inner portion, the rear portion, and the retainer bracket are coupled together.

8. The seat back pocket of claim 6, wherein an upper portion and a part of a lateral portion of the side portion each include a plurality of cutouts, and wherein each of the plurality of cutouts includes a first zipper rail positioned at a first end of the cutout and a second zipper rail positioned at a second end of the cutout, the first zipper rail and second zipper rail facing each other, and the seat back pocket further comprises at least one zipper slider coupled to the one of the first zipper rail and the second zipper rail.

9. The seat back pocket of claim 6, wherein the front portion is thicker than the side portion.

10. The seat back pocket of claim 6, wherein the front portion includes a first curved portion at a first end of the front portion and a second curved portion at a second end of the front portion.

11. The seat back pocket of claim 6, wherein the support portion includes a plurality of protruding portions, and the plurality of protruding portions are spaced apart along a transverse direction and protrude in a thickness direction.

12. A manufacturing method of a seat back pocket for vehicles, the manufacturing method comprising:
bonding a backing cloth to a surface of a polymer foam by hot-melt treatment;
performing a primary hot forming of the polymer foam;
bonding a polyurethane outer cloth to the other surface of the polymer foam and performing a secondary hot forming; and
performing a cold forming of the polymer foam and the polyurethane outer cloth.

13. The manufacturing method of claim 12, wherein the primary hot forming is performed at 180° C. to 190° C.

14. The manufacturing method of claim 12, wherein the secondary hot forming is performed at 120° C. to 130° C.

15. The manufacturing method of claim 12, wherein the cold forming is performed at room temperature (20° C.±5° C.).

16. The manufacturing method of claim 12, further comprising:
securing a retainer bracket, coupled to a vehicle seatback panel, to a front portion of the seat back pocket, after performing the cold forming of the polymer foam and the polyurethane outer cloth.
